(19) United States
(12) Patent Application Publication
(10) Pub. No.: US 2024/0051247 A1
(43) Pub. Date: Feb. 15, 2024

(54) PORTABLE TIRE REPAIRING TOOL

(71) Applicant: Nicolaas Jacobus Ferreira, Gauteng (ZA)

(72) Inventor: Nicolaas Jacobus Ferreira, Gauteng (ZA)

(21) Appl. No.: 17/885,409

(22) Filed: Aug. 10, 2022

(51) Int. Cl. B29C 73/08

(52) U.S. Cl. CPC B29C 73/08; B29L 2030/00

(57) ABSTRACT

A portable tire repairing tool having a first shell and a second shell is provided, same are connected at an opening via threads, forming a box body having an accommodating cavity, operating members are stored in the box body; the opening of the first shell or the second shell is symmetrically provided with at least two positioning notches in a direction away from the opening, a first positioning portion and a second positioning portion are arranged at positions corresponding to the positioning notches on two side walls of the connecting rod of the operating members. When the operating members are connected to the positioning notches of the connecting rod, the box body formed by the first shell and the second shell is used as a handle portion of the operating members, facilitating use. After use, same can be detached and received inside the box body, facilitate portability.

### FIELD OF TECHNOLOGY

The present invention relates to a tire repairing tool, and in particular to a portable tire repairing tool.

### BACKGROUND

When people are in, the process of driving or riding, same sometimes encounter the phenomenon that the tire is pinned, and sometimes same need to repair the tire by themselves. However, a handle portion of a common tire repairing tool is fixedly connected to operating members in a cross form, which is not detachable and takes up a large space and does not facilitate portability. Some tools which, are movably inserted at an end portion of the handle of the repairing tool have a short moment arm, when the handle rotates during use, which does not facilitate operation.

### SUMMARY

The objective of the present invention is to provide a portable tire repairing tool which can be detached and stored, the volume after storage is smaller, and the handle and the operating members are stably installed and convenient to use during installation and use.

In order to achieve the above-mentioned objective, the present invention provides the following technical solutions:

a portable tire repairing tool, comprising a first shell and a second shell, wherein the first shell and the second shell are both provided with an opening, the first shell is provided with a first connecting end at the opening, and the second shell is provided with a second connecting end at the opening, wherein the first shell and the second shell are detachably connected by means of the first connecting end and the second connecting end, so as to form a box body having an accommodating cavity, and a plurality of operating members are stored in the box body; the first connecting end or the second connecting end is symmetrically provided with at least two positioning notches in a direction away from the opening, and the operating members are provided with a first positioning portion and a second positioning portion cooperating with the positioning notches for positioning.

Further, the first connecting end and the second connecting end form a coinciding common connecting segment in a connection state; the depth of the positioning notches is greater than one half of the width of the common connecting segment and less than the sum of the width of the common connecting segment and the width of the operating members.

Further, the first connecting end is provided with an external thread, and the second connecting end is provided with an internal thread; the first shell and the second shell are in threaded connection with the internal thread by means of the external thread.

Further, the positioning notches comprises a first positioning notch and a second positioning notch.

Further, the operating members comprise a threaded drill, a fork drill, and a tire repair rubber strip.

Further, the operating members comprise a connecting rod, wherein the first positioning portion and the second positioning portion are both arranged on the connecting rod, and the operating members are fixed to the first shell or the second shell by means of the cooperation between the first positioning portion and the first positioning notch and the cooperation between the second positioning portion and the second positioning notch.

Further, the first positioning portion is arranged at an end portion of the connecting rod; when the operating members are installed with the first shell or the second shell, a top end of the connecting rod is in the same plane as an outer surface of a housing of the first shell or the second shell.

Further, the first positioning portion and the second positioning portion both comprise two opposite positioning grooves, and the width of the positioning grooves corresponds to the first positioning notch and the second positioning notch.

Further, outer surfaces of side walls of the first shell and the second shell are provided with anti-slip netting cracks, and the anti-slip netting cracks are configured for increasing the friction between hands of a user and the shells.

Further, the first shell, the second shell, the threaded drill and the fork drill are all made of an anti-corrosion and anti-rust material.

It can be seen from the analysis that the present invention discloses a pottable tire repair tool, wherein the first shell and the second shell are detachably connected, so as to form a box body having an accommodating cavity, and a limiting space of the connecting rod of the operating members is formed between the positioning notches of one shell and an abutting end of the other shell. When the operating members are connected to the positioning notches of the connecting rod, the box body formed by the first shell and the second shell is used as a handle portion of the operating members, thereby facilitating use. After use, the operating members can be detached and received inside the box body, facilitate portability.

### BRIEF DESCRIPTION OF THE DRAWINGS

The drawings of the specification which form a part of the present application are used to provide a further understanding of the present invention. The illustrative embodiments of the present invention and the explanation thereof are used to explain the present invention, and do not constitute undue limitations on the present invention, wherein

FIG. 1 is a structural schematic diagram in an embodiment of the present invention;

FIG. 2 is a structural schematic diagram of a storage state in an embodiment of the present invention;

FIG. 3 is a structural schematic diagram of split structures of, a first shell and a second shell in an embodiment of the present invention;

FIG. 4 is a structural schematic diagram of a threaded drill arranging positioning grooves in an embodiment, of the present invention;

FIG. 5 is a schematic structural diagram of a threaded drill in an embodiment of the present invention when it is limited and clamped in a first shell;

FIG. 6 is a schematic diagram of a cross-sectional structure at a clamping position between a threaded drill and a first shell in an embodiment of the present invention;

FIG. 7 is a schematic diagram of a use state of the installation of a threaded drill in an embodiment of the present invention; and

FIG. 8 is a schematic diagram of an enlarged structure of an area A circled by the dotted line in FIG. 7;

### DESCRIPTION OF REFERENCE NUMERALS

1—first shell; 10—first connecting end; 101—internal thread; 2—second shell; 20—second connecting end; 201—external thread;
3—operating member; 30—common connecting segment; 31—connecting rod; 301—first positioning portion; 302—second positioning, portion;
4—positioning notch; 41—first positioning notch; 42—second positioning notch; anti-slip netting crack.

### DETAILED DESCRIPTION OF THE INVENTION

Hereinafter, the present invention will be described in detail with reference to the drawings in combination with embodiments. Each example is provided by way of explanation of the present invention, but does not limit the present invention. Actually, it will be clear to those skilled in the art that modifications and variations can be made in the present invention without departing from the scope or spirit of the present invention. For example, features shown or described as part of one embodiment can be used in another embodiment to produce yet another embodiment. Therefore it is intended that the present invention include such modifications and variations as come within the scope of the appended claims and their equivalents.

In the description of the present invention, terms such as “longitudinal”, “traverse”, “upper”, “lower”, “front” “rear”, “left”, “right”, “vertical”, “horizontal”, “top”, “bottom”, are based on orientation or position relationships shown in the drawings, are merely to facilitate the description of the present invention and simplify the description, instead of requiring the present invention must be constructed and operated in particular orientations, and cannot be construed as limiting the present invention. Terms such as “connected”, “connection” and “arrange” used in the present invention should be understood in broad sense, for example, can be fixed connection or detachable connection; can be directly connected or indirectly connected by means of an intermediate component; can be a wired electrical connection, a radio connection, or a wireless communication sisal connection. For a person of ordinary skill in the art, the specific meanings of the above terms can be understood according to specific situations.

One or more examples of the present invention are shown in the attached drawings. The detailed description uses numeric and letter references to refer to the features in the drawings. Similar or analogous references in the drawings and descriptions have been used to refer to similar or references parts of the present invention. As used herein, terms such as “first”, “second” and “third” are used interchangeably to distinguish one member from another, and are not intended to indicate the position or importance of individual member.

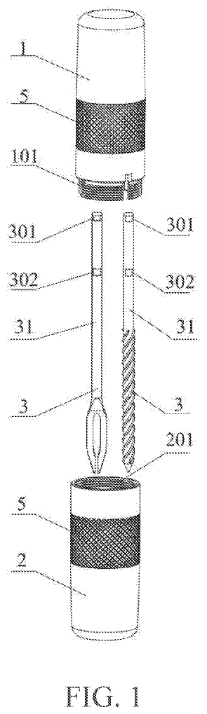

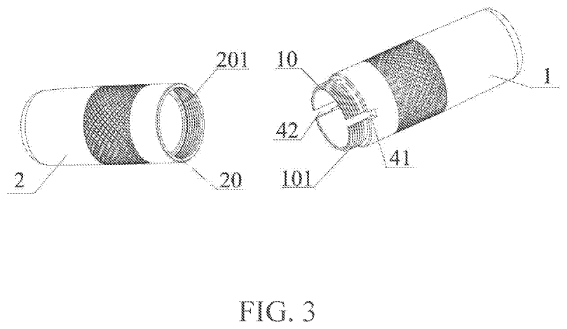

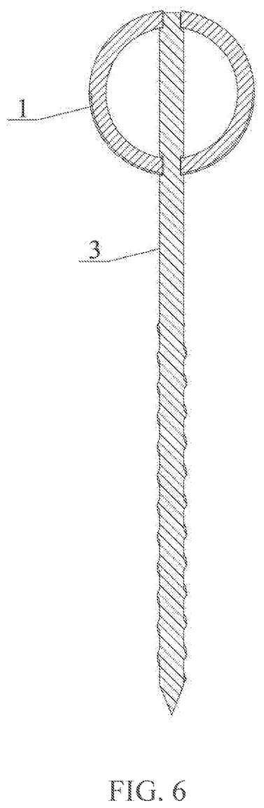

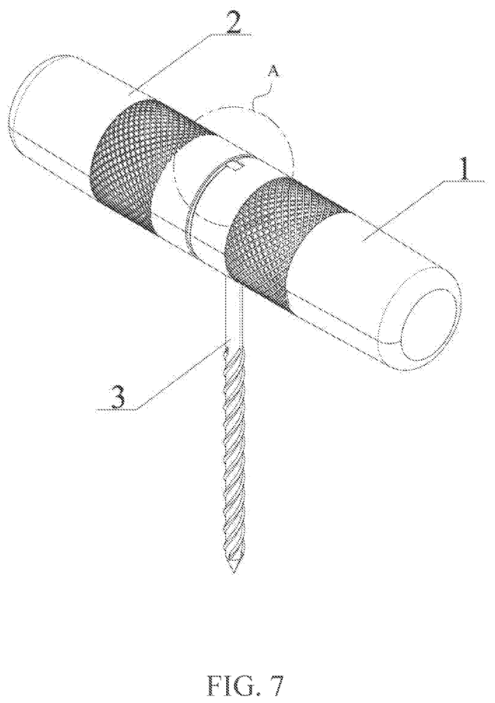

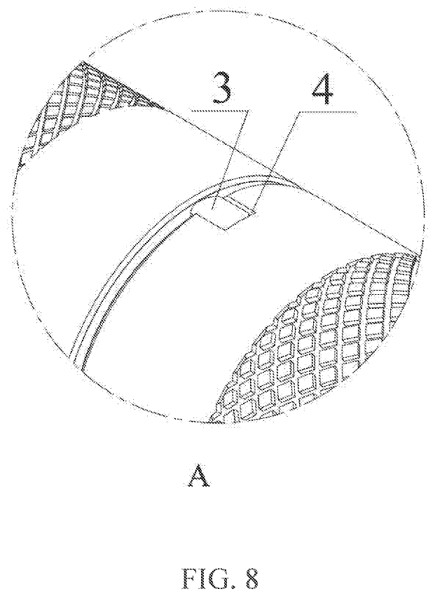

As shown in FIGS. 1 to 8, according to the embodiment of the present invention, a portable tire repairing tool is provided, comprising a first shell 1 and a second shell 2, wherein the first shell 1 and the second shell 2 are both provided with an opening, and the first shell 1 is provided with a first connecting end 10 at the opening, and, the second shell 2 is provided with a second connecting end 20 at the opening, wherein the first connecting end 10 is provided with an external thread 101, and the second connecting end 20 is provided with an internal thread 201; the first shell 1 and the second shell 2 are in threaded connection with the internal thread 201 by means of the external thread 101. The first shell 1 is in threaded connection with the second shell 2 by means of the first connecting end 10 and the second connecting end 20, so as to form a box body having an accommodating cavity, and a plurality of operating members 3 are stored in the box body; the first connecting end 10 or the second connecting end 20 is symmetrically provided with at least two positioning notches 4 in a direction away from the opening, which are the first position notch 41 and the second position notch 42 respectively.

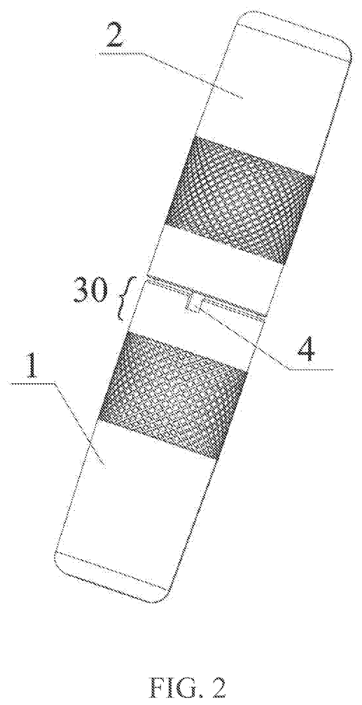

As shown in FIG. 2, when the first connecting end 10 is provided with two positioning notches 4, a spacing space of the connecting rod of the operating members 3 is formed between the positioning notches 4 and the end portion of the second connecting end 20. Correspondingly, the operating members 3 comprise a connecting rod 31, and the connecting rod 31 is provided with a first positioning portion 301 and a second positioning portion 302 cooperating with the two positioning notches 4. The operating members 3 are fixed to the first shell 1 by means of the cooperation between the first positioning portion 301 and the first positioning notch 41 and the cooperation between the second positioning portion 302 and the second positioning notch 42. After the first shell 1 is connected to the second shell 2, the end portion of the second connecting end 20 of the second shell 2 abuts against the operating members 3. If the second connecting end 20 is provided with positioning notches, a spacing space of the connecting rod of the operating members 3 is formed between the positioning notches and an end portion of the first connecting end 10.

The first connecting end 10 and the second connecting end 20 form a coinciding common connecting segment 30 in a connection state; the depth of the positioning notches 4 are greater than one half of the width of the common connecting segment 30 and less than the sum of the width of the common connecting segment 30 and the width of the operating members 3, which ensures that the first connecting end 10 and the second connecting end 20 form a stable connection when the operating members 3 are installed in the positioning notches 4, and ensures that the end portion of the first connecting end 10 or the second connecting end 20 abuts against the operating members 3, thus fixing the operating members 3 in the positioning notches 4.

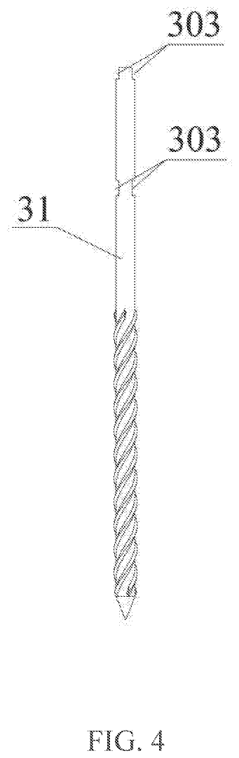

As shown in FIG. 4, the first positioning portion 301 and the second positioning portion 302 both comprise two opposite positioning grooves 303, and the width of the positioning grooves 303 corresponds to the first positioning notch 41 and the second positioning notch 42. It can not only limit the relative rotation between the operating members 3 and the first shell 1, but, also limit the movement of the operating members 3 along an axis direction thereof. As shown in FIG. 4, the connecting rod 31 of the operating members 3 is respectively provided with four positioning grooves 303. When in use, a position corresponding to the positioning grooves 303 are respectively clamped with the first positioning notch 41 and the second positioning notch 42, then the second shell 2 is connected to the first housing 1, such that the second connecting end 20 of the end portion of the second shell 2 abuts against an outer wall of the connecting rod, and the connecting rod 31 of the operating members 3 is fixed in the positioning notches 4, so as to prevent the connecting rod from being inconvenient to use due to unstable installation during use.

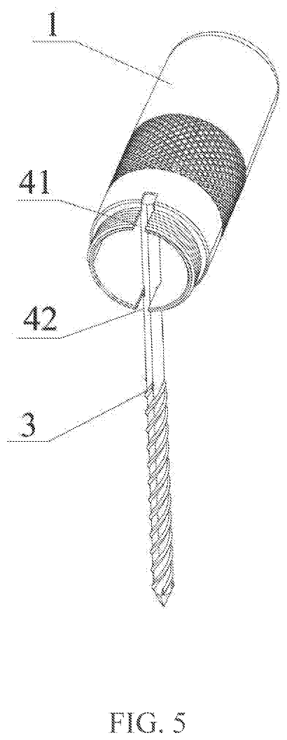

For the convenience of facilitating use, the first positioning portion 301 is arranged at the end portion of the connecting rod 31 as shown in FIG. 5; when the operating members 3 are installed with the first shell 1 or the second shell 2, a top end of the connecting rod 31 is on the same plane as an outer surface of a housing of the first shell 1 or the second shell 2, thereby facilitating use and operation. In order to facilitate the screwing connection between the first shell 1 and the second shell 2, such that the second connecting end 20 of the second shell 2 can abut and fix the connecting rod of the operating members 3, the outer surfaces of side walls of the first shell 1 and the second shell 2 are provided with anti-slip, netting cracks 5, which increase the friction between hands of a user and the shells. The operating members 3 comprises a threaded drill, a fork drill, and a tire repair rubber strip, and the first shell 1, the second shell 2, the threaded drill and the fork drill are all made of an anti-corrosion and anti-rust material, such that the service life of the tool is prolonged.

Bottoms of inner sides of the first shell 1 and the second shell 2 are further provided with a plurality of jacks for placing the operating members. The size of the jacks is matched with the end portion of the connecting rod of the operating members, and same are used for limiting and storing each operating members, so as to prevent the operation members from colliding and friction on an inner surface of the box body and causing damage to the surface of the operation members.

From the above description, it can be seen that the above-mentioned embodiments of the present invention achieve the following technical effects:
1. the first shell and the second shell are detachably connected, so as to form a box body having an accommodating cavity, and a limiting space of the connecting rod of the operating members is formed between the positioning notches of one shell and an abutting end of the other shell. When the operating members are connected to the positioning notches of the connecting rod, the box body formed by the first shell and the second shell is used as a handle portion of the operating members, thereby facilitating use. After use, the operating members can be detached and received inside the box body, facilitate portability.
2. Two sides of the operating members are respectively provided with four limiting grooves. When the positioning notches of the first shell or the second shell is clamped with the positioning portions, the relative rotation between the operating members and the shells can be limited, and the movement of the operating members along an axis direction thereof can also be limited, so as to prevent the connecting rod from being inconvenient to use due to unstable installation during use.
3. The end portion of the connecting rod of the operating members is provided with a first positioning portion, and the second positioning portion is arranged corresponding to the first positioning portion, such that the end portion of the connecting rod does not extend out of the outer surface of the shell when the operating members are installed in the positioning notches, thereby facilitating use and operation. Compared with the prior art, the tire repairing tool of the present invention is to facilitate portability, and is stably installed during the process of use, thereby facilitating use.

The foregoing descriptions are merely preferred embodiments of the present invention, but are not intended to limit the present invention, which may be subject to various modifications and variations for persons skilled in the art. Any modification, equivalent replacement, improvement, or the like made within the spirit and principle of the present invention should fall within the protection scope of the present invention.

1. A portable tire repairing tool, comprising a first shell and a second shell,
wherein the first shell and the second, shell are both provided with an opening, the first shell is provided with a first connecting end at the opening, and the second shell is provided, with a second connecting end at, the opening, wherein the first shell and, the second shell are detachably connected by means of the first connecting end and the second connecting end, so as to form a box body having an accommodating cavity, and, a plurality of operating members are stored in the box body;
the first connecting end or the second connecting end is symmetrically provided with at least two positioning notches in a direction away from the opening, and the operating members are provided with a first positioning portion and a second positioning portion cooperating with the positioning notches for positioning.

2. The portable tire repairing tool of claim 1,
wherein the first connecting end and the second connecting end form a coinciding common connecting segment in a connection state; the depth of the positioning notches is greater than one half of the width of the common connecting segment and less than the sum of the width of the common connecting segment and the width of the operating members.

3. The portable tire repairing tool of claim 2,
wherein the first connecting end is provided with an external thread, and the second connecting end is provided with an internal thread; the first shell and the second shell are in threaded connection with the internal thread by means of the external thread.

4. The portable tire repairing tool of claim 3,
wherein the positioning notches comprises a first positioning notch and a second positioning notch.

5. The portable tire repairing tool of claim 4, wherein the operating members comprise a threaded drill, a fork drill, and a tire repair rubber strip.

6. The portable tire repairing tool of claim 4,
wherein the operating members comprise a connecting rod, wherein the first positioning portion and the second positioning portion are both arranged on the connecting rod, and the operating members are fixed to the first shell or the second shell by means of the cooperation between the first positioning portion and the first positioning notch and the cooperation between the second positioning portion and the second positioning notch.

7. The portable tire repairing tool of claim 6,
wherein the first positioning portion is arranged at an end portion of the connecting rod; when the operating members are installed with the first shell or the second shell, a top end of the connecting rod is in the same plane as an outer surface of a housing of the first shell or the second shell.

8. The portable tire repairing tool of claim 4,
wherein the first positioning portion and the second positioning portion both comprise two opposite positioning grooves, and the width of the positioning grooves corresponds to the width of the first positioning notch and the second positioning notch.

9. The portable tire repairing tool of claim 3,
wherein outer surfaces of side walls of the first shell and the second shell are provided with anti-slip netting cracks, and the anti-slip netting cracks are configured for increasing the friction between hands of a user and the shells.

10. The portable tire repairing tool of claim 4,
wherein the first shell, the second shell, the threaded drill and the fork drill are all made of an anti-corrosion and anti-rust material.
